(19) United States
(12) Patent Application Publication
(10) Pub. No.: US 2026/0064367 A1
(43) Pub. Date: Mar. 5, 2026

(54) DECENTRALIZED MULTI-RANDOM NUMBER GENERATOR ARCHITECTURE

(71) Applicant: QUALCOMM Incorporated, San Diego, CA (US)

(72) Inventors: Nicolas Thaddee COURTOIS, Mougins (FR); Matthew MCGREGOR, Huntington Beach, CA (US); Anthony MAURE, Grasse (FR); Frederic AMIEL, Nice (FR)

(21) Appl. No.: 18/820,048

(22) Filed: Aug. 29, 2024

(51) Int. Cl. G06F 7/58; H04L 9/08

(52) U.S. Cl. CPC G06F 7/582; H04L 9/0869

(57) ABSTRACT

Systems and techniques are provided for random number generation. For instance, a process can include generating, using a first random number generator of a plurality of random number generators, a first random number; inputting the first random number to a first flow engine of a plurality of flow engines, wherein the first flow engine is coupled to a random number consumer, of one or more random number consumers, through a first set of flow engines, of the plurality of flow engines, wherein the plurality of flow engines are unclocked; randomly transforming, by the first set of flow engines, the first random number to a second random number; and buffering the second random number from the first set of flow engines for output to the random number consumer.

### FIELD

Aspects of the present disclosure generally relate to device security. For example, aspects of the present disclosure relate to a decentralized multi-random number generate architecture that may be used by devices and/or sub-systems of devices as a source of randomness.

### INTRODUCTION

Computing devices typically store sensitive data owned by users or enterprises, with firmware or operating system software on the computing devices owned by a computing device or secure module manufacturer. To help secure computing devices, cryptographic keys may be used to encrypt and/or decrypt data for use by the computing device. Often, these cryptographic keys may be generated based on a random number or seed. In some cases, this random number may be provided by a random number generator (RNG) of the computing device. Relatively large quantities of ephemeral randomness may be useful as input in many cryptographic protocols and their sub-protocols, such as in digital signatures, randomized encryption modes, or in zero-knowledge proofs. In some cases, extra randomness may also be added to perform data masking, secret sharing or splitting, or secure multi-party computation (MPC) and to create an environment of dummy signals and data, obfuscating the computations and their private or intermediate data. However, a centralized RNG for a device may potentially be a single point of failure and may become a target for attackers. Techniques to help enhance security for RNGs may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for device security. According to at least one illustrative example, an electronic device is provided. The electronic device includes a memory system comprising instructions; and a processor system coupled the memory system. The processor system is configured to: generate, using a first random number generator of a plurality of random number generators, a first random number; input the first random number to a first flow engine of a plurality of flow engines, wherein the first flow engine is coupled to a random number consumer, of one or more random number consumers, through a first set of flow engines, of the plurality of flow engines, wherein the plurality of flow engines are unclocked; randomly transform, by the first set of flow engines, the first random number to a second random number; and buffer the second random number from the first set of flow engines for output to the random number consumer.

As another example, a method for random number generation is provided. The method includes: generating, using a first random number generator of a plurality of random number generators, a first random number; inputting the first random number to a first flow engine of a plurality of flow engines, wherein the first flow engine is coupled to a random number consumer, of one or more random number consumers, through a first set of flow engines, of the plurality of flow engines, wherein the plurality of flow engines are unclocked; randomly transforming, by the first set of flow engines, the first random number to a second random number; and buffering the second random number from the first set of flow engines for output to the random number consumer.

In another example, a non-transitory computer-readable medium having stored thereon instructions is provided. The instructions, when executed by at least one processor, cause the at least one processor to: generate, using a first random number generator of a plurality of random number generators, a first random number; input the first random number to a first flow engine of a plurality of flow engines, wherein the first flow engine is coupled to a random number consumer, of one or more random number consumers, through a first set of flow engines, of the plurality of flow engines, wherein the plurality of flow engines are unclocked; randomly transform, by the first set of flow engines, the first random number to a second random number; and buffer the second random number from the first set of flow engines for output to the random number consumer.

As another example, an apparatus for random number generation is provided. The apparatus includes means for generating, using a first random number generator of a plurality of random number generators, a first random number; means of inputting the first random number to a first flow engine of a plurality of flow engines, wherein the first flow engine is coupled to a random number consumer, of one or more random number consumers, through a first set of flow engines, of the plurality of flow engines, wherein the plurality of flow engines are unclocked; means for randomly transforming, by the first set of flow engines, the first random number to a second random number; and means for buffering the second random number from the first set of flow engines for output to the random number consumer.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations (e.g., processors (such as CPU, GPU, DSP, NPU), memory or storage component(s), electronic blocks which ensure I/O connectivity and multimedia capabilities, and hardware modules associated with sensors or processing data from sensors, Image Signal Processors (ISPs), embedded discrete secure hardware modules, etc. or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example implementation of a system-on-a-chip (SoC), in accordance with some examples;

FIG. 2 is block diagram illustrating a decentralized multi-random number generator, in accordance with aspects of the present disclosure;

FIG. 3 is a flow diagram illustrating an example of a process for generating random numbers, in accordance with aspects of the present disclosure;

FIG. 4 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Computing devices can store sensitive data. The privacy and/or security of such sensitive data is often ensured using cryptography. Cryptography generally relies on the use of long random numbers, or keys, which are generated based on random numbers provided by a random number generator (e.g., seed). However, these random number generators (RNGs) may be subject to attacks, including side channel attacks, which may reveal the seed or other information for generating a key. To avoid such issues, it may be useful to use a decentralized RNG with multiple high-speed RNG sources.

Systems, apparatuses, processes (also referred to as methods), and computer-readable media (collectively referred to as “systems and techniques”) are described herein for a decentralized multi-random number generator. For example, multiple RNG sources may generate random numbers. In some cases, the multiple RNG sources may be designed by different independent teams to help avoid potential for backdoors and/or to avoid any single engineer/employee/person from knowing the full specification of the system. In some cases, these RNG sources may be based on quantum noise, thermal noise, Zener diodes, noise generating diodes or the like. In some cases, the RNG sources may be based on oscillators. In some cases, the RNG sources may contain a unique secret string of bits burnt in using one-time electronic fuses by the manufacturer as a part of manufacturing. In some cases, the RNG sources may contain one or more Physical Unclonable Functions (PUFs). In some cases, the RNG sources are evaluated by common criteria security evaluations. The random numbers may be input to a set of flow engines (e.g., a river of flow engines). The flow engines may be implemented using asynchronous digital logic and may be unclocked. Asynchronous digital logic may be digital circuits which are unclocked and thus do not use a clock signal to determine when to perform an operation. Rather, asynchronous digital logic may change state as soon as changes in the inputs are input. The set of flow engines may connect one or more termination points (e.g., RNG outlets) where data may be buffered and formatted. The termination points may be coupled to one or more consumers of random numbers, such as circuits for performing cryptographic operations.

Each flow engine may perform an operation and different types of flow engines may perform different types of operations. These operations may include a permutation operation, an exclusive or (XOR) operation, a buffer operation, a zeroing operation, or an audit operation. The permutation operation may randomly rearrange a number of bits of an input set of bits (e.g., input random number). The XOR operation may apply an XOR to a set of input bits such that the XOR is true if and only if a number of inputs of true are odd. The buffer operation may receive input from the other flow engines and buffer the received input until a stable set of random numbers are generated and can be output to a random number consumer. The zeroing operation may zero out a number of input bits or pause a river of flow engines for an amount of time or otherwise reduce power consumption, for example, by pausing and/or throttling a change, flow, data, and/or electrical activity, in one or more parts of a river of flow engines for an amount of time. The audit operation may test for randomness. The flow engines may randomly transform inputs, such as random numbers from the RNG, using the permutation operation, XOR operation, and zeroing operation.

In some cases, the set of flow engines may be a subset of a plurality of flow engines. The plurality of flow engines may include dummy engines. The dummy engines may be separate (e.g., distinct) from flow engines in a set of flow engines in that output from the dummy engines may not be used to determine a random number that is passed to a random number consumer. The dummy engines may also obtain input values (e.g., input random numbers) from a source (e.g., an RNG source, portion of sensor information, etc.) separate from where a set (or river) of flow engines obtains input values. In some cases, the dummy engines may help generate noise emissions (e.g., radio frequency (RF) emissions, heat emissions, etc.) that may be used to mask emissions of other components, such as flow engines of the set of flow engines, random number consumers, RNGs, etc. In some cases, flow engines may be placed around a component, such as the random number consumer, to help mask emissions of the component. In some cases, multiple sets of flow engines may share certain flow engines. For example, a mixer flow engine may be included in a first set of flow engines and a second set of flow engines. The mixer flow engine may mix inputs from the first set of flow engines and second set of flow engines.

In some cases, how RNGs, flow engines, and random number consumer outlets may be physically placed on a silicon chip may be determined with the help of place and route tools. In some cases, the place and route tools may randomly determine how many flow engines may be included in a set of flow engines (subject to some restrictions, such as a minimum number of flow engines perform permutation operations in the set of flow engines). The place and route tool may also randomly organize the operations performed by the flow engines (e.g., by randomly selecting a type of flow engine) in the set of flow engines. In some cases, the flow engines contain many constant bits of type “RANDOM CONSTANT” (e.g., “DON'T CARE” type). The place and route algorithms can fix these bits to 0 or 1 at their convenience in order to simplify the circuit, such as in the case of local congestion. For example, an XOR gate with one input at 0 may be removed and replaced by a NOT gate if one input is at 1. In some cases, this may be performed for XOR gates, and not for non-linear gates, to avoid providing the place and route algorithm too many opportunities to accidentally or deliberately degrade the cryptographic security by lowering the entropy of the output of the modified gates.

Various aspects of the present disclosure will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The term “mobile device” is used herein to refer to any one or all of cellular telephones, smartphones, Internet-of-things (IOT) devices, personal or mobile multi-media players, laptop computers, tablet computers, ultrabooks, palm-top computers, wireless electronic mail receivers, multimedia Internet enabled cellular telephones, wireless gaming controllers, smart cars, autonomous vehicles, and similar electronic devices which include a programmable processor, a memory and circuitry for sending and/or receiving wireless communication signals to/from wireless communication networks. While the various embodiments are particularly useful in mobile devices, such as smartphones and tablets, the embodiments are generally useful in any electronic device that includes secure boot circuitry for securing access to the electronic device.

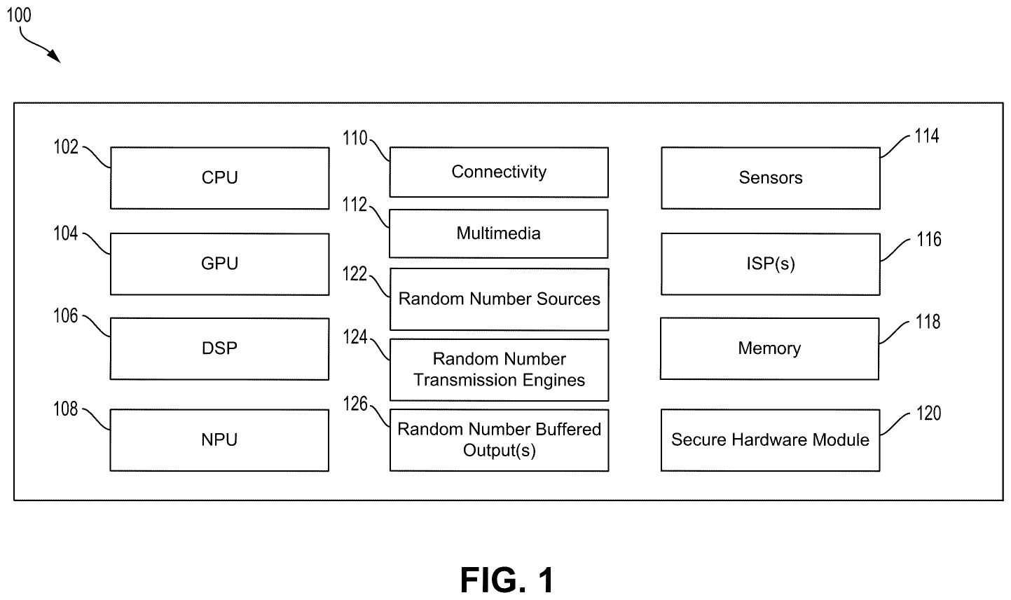

Various aspects of the techniques described herein will be discussed below with respect to the figures. FIG. 1. FIG. 1 illustrates an example implementation of a system-on-a-chip (SoC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

In some cases, the SoC 100 may include the CPU 102, which is based on an ARM instruction set. The SoC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SoC 100 may also include a sensor processor 114, image signal processors (ISPs) 116, secure hardware module 120, one or more random number sources 122, one or more random number transmission engines 124, and/or one or more random number buffered outputs 126.

The secure hardware module 120 may include fuses, replay protected memory block (RPMB), secure bits, secure flags, security enabled hardware, secure memory, or hardware, software, or firmware used to implement a secure portion of the operating system, a secure operating system (SOS), a trusted execution environment (TEE), trusted platform module (TPM), etc. The secure hardware module 120 may be used to process and/or store sensitive data in an environment that is segregated from the rich execution environment in which the operating system and/or applications may be executed. The secure hardware module 120 can be configured to execute trusted applications that provide end-to-end security for sensitive data by enforcing confidentiality, integrity, and protection of the sensitive data stored therein. The secure hardware module 120 can be used to store encryption keys, access tokens, and other sensitive data. In some cases, the secure hardware module 120 may serve as a RoT for the SoC 100. For example, the secure hardware module 120 may provide for the secure generation of cryptographic keys, limitations on the use of such cryptographic keys, and may contain one or more cryptographic keys or elements that may be used to authenticate the SoC 100. In some cases, the RoT may serve to anchor a chain of trust to validate other hardware and/or software. In some cases, the secure hardware module 120 may be implemented as a secure area of the CPU 102, as a part of the SoC 100, or any combination thereof. In some cases, the RoT may produce bits at one personalization stage or at the boot time, which may be transmitted and stored to reconfigure the state of one of the initial random number sources 122 (e.g., RNG), in order to diversify random number generation from one chip to another, and to avoid long term regularities or side channels, machine learning, or reverse engineering opportunities focused on a random number source 122.

In some cases, the SoC 100 may include the random number sources 122 (e.g., RNG). In some cases, the random number sources 122 may be a part of the secure hardware module 120 or another module of the SoC 100. The random number sources 122 may provide random numbers which may then be used to generate cryptographic keys, for cryptography, or other application. The SoC 100 may also include one or more random number transmission engines 124. The one or more random number transmission engines 124 may transport random numbers generated by the random number sources 122 to one or more random number buffered outputs 126. The one or more random number buffered outputs 126 may output the random numbers to random number consumers.

In some cases, a SoC 100 may include a primary random number source 122that may be used with multiple consumers of the random numbers. However, using a single random number source 122, even with a very high quality RNG, with multiple consumers may result in security shortcomings. For example, where multiple consumers share a single RNG, the multiple consumers are logically and physically connected via wires (e.g., traces). These wires may create capacitive and/or inductive coupling of signals which may be correlated. For example, transmitting random numbers at high speeds over distances can use a fair amount of energy per bit and cause sufficient physical coupling capacities to emit radio frequency (RF) signals that may be observed and passed into a machine leaning model that learns these correlations to predict the random numbers that are being transmitted. Additionally, exfiltrating the state at one RNG may be used to recover the original seed, which may be used to comprise other devices. To avoid such issues, it may be useful to use a decentralized RNG with multiple high-speed RNG sources. Output from these multiple RNGs may be transmitted and modified concurrently to produce derived randomness with little correlation between various points in time and space using asynchronous digital logic.

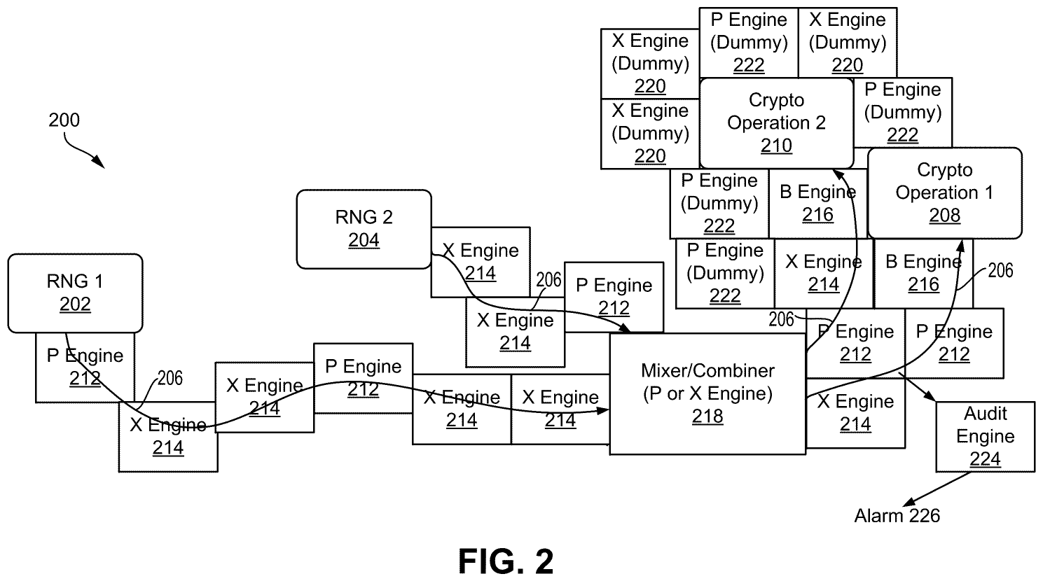

FIG. 2 is block diagram illustrating a decentralized multi-random number generator 200, in accordance with aspects of the present disclosure. FIG. 2 includes a first RNG 202 and a second RNG 204. In some cases, the first RNG 202 may be separately designed from the second RNG 204 (e.g., designed by separate teams within an organization, by different organizations, different open sourced RNG designs, etc.). Each RNG may generate a random number. The random numbers generated by the RNGs may be relatively long (e.g., >256 bits), such as 512 bits. The RNGs may provide this random number to a river 206 of flow engines. The river, as used herein, may refer to a set of flow engines (e.g., series of flow engines) that may couple an RNG, such as the first RNG 202, to one or more random number consumers. Illustrative examples of random number consumers include a first crypto operation 208 and a second crypto operation 210. Random number consumers may include, for example, cryptographic protocols, randomized encryption modes, zero-knowledge proofs, etc., executing, for example, on a secure hardware module. In some cases, the set of flow engines may include a random number (within limits) of flow engines of a random type (within limits) of flow engines. In some case, rivers may share one or more flow engines.

The flow engines may use asynchronous digital logic to perform a specific task. For example, certain flow engines may (e.g., should) modify the random numbers generated by the first RNG 202 and/or second RNG 204 while transmitting the random numbers to the random number consumers. While these modifications to the random numbers do not necessarily add entropy to the random numbers, the modifications may make it difficult for an attacker to determine a value of the random numbers while still preserving entropy.

Asynchronous digital logic may be digital circuits which are unclocked. Asynchronous digital logic may be unclocked as asynchronous digital logic does not use a clock signal to determine when to perform an operation. In some cases, asynchronous digital logic may change state in response to changes in the inputs. For example, data signals may be propagated through an asynchronous circuit (e.g., circuit using asynchronous digital logic) when an input signal(s) stabilize and when the operating conditions (e.g., parameters) of the asynchronous circuit are met without waiting for a clock signal. As input signal(s) may be operated on as soon as they are presented to the asynchronous circuit, asynchronous circuits may be well suited for high-speed operations. Additionally, operating on input signals as soon as they are presented can obscure emissions (e.g., RF, heat, etc.) from the asynchronous circuits as the operations of multiple asynchronous circuits may appear blurred together with no discrete operations per clock tick. In some cases, operations of the asynchronous circuit may be based on relative timing of inputs/signals to the asynchronous circuit, resulting in potential race conditions. While this propensity to race conditions can make working with asynchronous circuits difficult, these race conditions may be useful for the decentralized multi-random number generator 200 as they can make reverse engineering/determining correlations between RF signals of asynchronous circuits difficult as it can be difficult to determine an order in which operations were performed.

In some cases, there may be different types of flow engines and the different types of flow engines may perform different tasks. FIG. 2 includes three types of flow engines, P engines 212, X engines 214, and B engines 216. Other flow engines may also be possible, such as Z engines. In some cases, P engines 212 may perform a cryptographic permutation on an input. For example, if a random number is input to a P engine, the P engine may randomly rearrange a number of bits of the random number. In some cases, there may be multiple types of P engines 212. The types of P engines 212 may be based on a type of permutation performed. For example, one type of P engine may perform one round of Ascon permutation on 320 bits of an input number/string. Another type of P engine may perform an advanced encryption standard (AES) permutation using a block size of 128 bits. In some cases, multiple rivers may use a particular P engine in parallel, depending on how the P engines 212 are laid out (e.g., for a processor, SoC, etc.). Other types of P engines 212 may perform permutations using other permutation algorithms at various sizes (e.g., of a number of bits). In some cases, P engines 212 may be routed around one or more obstacles (e.g., another circuit on the processor/SoC). For example, a P engine may be split and implemented in multiple locations with traces connecting the multiple locations going around one or more obstacles.

The X engines 214 may perform an exclusive or (XOR) operation based on the input bits. For example, an X engine may perform one layer of randomly generated XORs, where each XOR operation may use 2-4 inputs. For example, an XOR4 (e.g., XOR with 4 input bits) may accept 4 input bits out of n bits of input (e.g., input random number(s) and output m output bits that are an XOR of the 4 input bits chosen at random. In some cases, a relatively simple (e.g., as compared to an RNG) pseudo RNG may be used to perform the random operations of the X engine.

In some cases, there may be different types of X engines 214. For example, different types of X engines 214 may accept different sizes of inputs. In some cases, different types of X engines 214 may change a size of the output as compared to the input. For example, a type of X engine may output more bits than are input (e.g., m>n). X engines which output more bits than input bits may be used, for example, in specific locations of the processor/SoC which more randomness may be needed, such as a location where more random number consumers are located, and producing and consuming increased randomness locally may be more efficient as compared to increasing an overall amount of randomness. X engines 214 which output more bits than input bits may also be used near audit engines as audit engines may have a large bandwidth and it may be easier for an audit engine to located biases or repeated patterns where more data (e.g., input bits) are available. Another type of X engine may be one which outputs fewer bits than are input (e.g., m<n). X engines which output fewer bits than are input may be used in areas of high density where a size of a river may be reduced to help physically fit the river and other components. In some cases, a number of bits of the river should not be reduced below a minimum size, such as 512 bits. In some cases, P engines 212, X engines 214, and Z engines may all transform the input random numbers and these constant changes may be made at a frequency greater than an operating frequency of the processor/SoC as the flow engines use asynchronous circuits which may perform operations as soon as inputs are provided.

In some cases, the set of flow engines may include mixers 218 (e.g., combiners). Mixers may be useful to resist attacks against, for example, a single RNG source, which may be compromised through exploits, side channel attacks (reverse engineering, recovery of initial state), insider/insider information, etc. Mixers may mix signals from various sources, including signals from a single source, and mixers do not need to be aware of where inputs are coming from. Mixers may be especially useful where two or more rivers are transmitting random numbers from two or more sources that are routed short distances. The mixers 218 may be a P engine or an X engine that may receive input from flow engines of multiple rivers and perform a permutation or XOR (respectively) operation on the inputs from multiple rivers. For example, a mixer 218 flow engine may be included in a first river. The mixer 218 flow engine may also be included in a second river. The mixer 218 flow engine may mix values of the first river and the second river by performing permutations or XOR operations using inputs from the first river and inputs from the second river. In some cases, the mixers 218 may mix the signals (e.g., random numbers of) multiple rivers.

The B engines 216 may perform a buffer operation and B engines 216 may be used where river 206 connects to a random number consumer (e.g., crypto operation 1 208, crypto operation 2 210, etc.). The B engines 216 may receive input from the other flow engines (e.g., P engines 212, X engines 214, etc.) and the B engines 216 may buffer the received input to produce a stable signal (e.g., set of random numbers) that is not changing and available to the random number consumer on a clock edge (e.g., when the random number consumer, using synchronous logic, may access the random number from the B engines 216). The B engines 216 may buffer the random numbers until a sufficient number of random numbers are received for the random number consumer. In some cases, the B engines 216 may randomly ignore or erase some bits for security reasons until a sufficient number of random bits are received and processed. The B engines 216 may have internal memory or flip-flops and may be stateful. The B engines 216 may provide stable output signals for the random number consumer such that the output signals should not change except at a clock edge. In some cases, each B engine output bit may be an XOR of a large number of bits which exist, at their input, in various moments in time, and also an XOR of inputs bits from at least two distinct physical areas of the SoC. In some cases, the distinct physical areas of the SoC may not be two or more wires routed near each other or areas having similar origins or logical pedigree. In cases where a B engine includes buffers with memory, bits from an internal state used for production of a local stable signal may be XORed with at least one bit from an external source. In some cases, the place and route algorithm may use a deterministic random number generator to decide which current and previous bits may be XORed together. Use of the deterministic random number generator may provide the place and route algorithm some freedom of choice (assuming the place and route algorithm permits such choices) where downsides to a fair and pseudo-random choice is reasonable and low as compared to native choices dictated by cost optimization metrics and algorithms in place.

In some cases, other flow engines for performing tasks may be included, such as Z engines. A Z engine may perform a zeroing operation to help reduce power consumption of a river. For example, a Z engine may zero out a number of input bits for a certain amount of time (e.g., 13 ns) and/or pause (e.g., oscillating between active and inactive) for a certain amount of time (e.g., 40 ns). In some cases, a Z engine may switch off a whole incoming river branch or outgoing river branch to help reduce power consumption.

In some cases, some flow engines may be dummy flow engines. FIG. 2 includes dummy P engines 222 and dummy X engines 220. Dummy flow engines may be similar to regular flow engines of the same type except that dummy flow engines are not on the river or that dummy flow engines are on a dead end. Thus, dummy flow engines may receive an input (e.g., from a regular flow engine) and calculate an output. This output may be input to another flow engine, but the output of dummy flow engine may not be used to provide input to a random number consumer.

In some cases, flow engines (either dummy or regular flow engines) may be wrapped around one or more other components (e.g., of the processor/SoC). For example, in FIG. 2, dummy P engines 222 and dummy X engines 220 surround a sensitive component, such as second crypto operation 210. Surrounding a sensitive component may help shield (e.g., mask) emissions of the sensitive component using emissions of the flow engines (e.g., noise emissions). In some cases, the flow engines may be relatively noisy with respect to emissions as they may perform multiple operations at a high frequency and these emissions may be relatively unpredictable due to, for example, numerous race conditions. In some cases, X engines 214 may be especially noisy as multiple XOR gates may flip based on a single change in an input and the XOR operation may be sensitive to race conditions. In some cases, attempts to prevent race conditions in the flow engines to reduce the energy consumption may be unnecessary and even potentially harmful, as the flow engines should not convey the original signal and should be transforming the signal at each step through mild or temporary randomness or unpredictability, based on fast transitions and race conditions at certain moments in time and a rich spectrum of observable electrical signals generated.

In some cases, audit engines 224 may also be included in a set of flow engines. Audit engines 224 may test randomness for faults, disfunction, and/or deliberate/accidental degradation of entropy. For example, the audit engines 224 may sample the random values of a flow engine that the audit engines 224 are connected to at some time interval and statistically test the random values for randomness. If the testing indicates that the sampled random number is sufficiently (e.g., statistically) random, then the audit engines 224 may output a bit indicating that the sampled random number is sufficiently (e.g., statistically) random. If this testing indicates that the sampled random number is not sufficiently (e.g., statistically) random, then the audit engines 224 may output a bit setting an alarm 226 (e.g., flag, interrupt, etc.) or an indication to throttle. In some cases, the alarms may be used to throttle or slow down crypto operations to reduce random number consumption, stop sensitive operations (e.g., of consumers of the random numbers), trigger a higher power mode to increase entropy and/or speed of transitions inside any part of the RNG producing infrastructure, etc. The indication to throttle may enable one or more Z engines of the decentralized multi-random number generator 200.

In some cases, a decentralized RNG system with multiple RNGs may enter a reduced power state in addition to, or in place of, including Z engines. For example, the decentralized RNG system may, to conserve power, switch off one or more (or all) of the rivers, stop saving bits for later re-use inside some flow engines such as mixer/combiner engines or any other place inside the RNG transmission and production infrastructure system, reduce a rate at which the RNGs generate bits (e.g., reducing a number of fresh (random) bits per clock cycle), reduce a clock rate of the RNGs, pausing the generation of fresh bits for x number of clock cycles, and so forth.

In some cases, random numbers from a decentralized RNG system may be used as input to other RNGs/pseudo RNGs (e.g., an RNG for a particular core of a processor), for example, as a seed to generate additional random numbers.

As indicated above, flow engines may be placed on the way (e.g., between) one or more RNGs and a random number outlet connector or consumer. In some cases, circuits for a processor/SoC (or components thereof) may be physically laid out during a part of a design process that may be referred to as a place and route stage. e.g., During the place and route stage, a design of where circuits/components should be placed on a limited amount of space on a silicon chip and how wires (e.g., traces) should be routed to the circuits/components may be generated. Given the complexity of modern processors/SoCs, place and route tools, such as electronic design automation (EDA), may be used. Place and route tools may receive predesigned components, such as the different types of flow engines, RNGs, random number consumers, outlets, standardized connectors, etc. and determine how to place and connect (e.g., route) these predesigned components based on metadata. The metadata may lay out rules, restrictions, and/or preferences for how the place and route tool may place and connect (e.g., route) these predesigned components. In some cases, place and route tools do not necessarily take into account cryptographic security components, such as flow engines, when laying out circuits/components. For example, place and route tools may not take into account/support using asynchronous circuits alongside synchronous circuits, adding a random number of certain components (e.g., flow engines), etc.

In some cases, it may be useful to modify tools that perform place and route operations (e.g., EDA tools) to support components dedicated to cryptographic operations (e.g., RNGs, flow engines, random number consumers, etc.) and to support additional rules, restrictions, and/or preferences for these components dedicated to cryptographic operations. For example, place and route tools may be modified to support asynchronous circuits, such as the multiple types of flow engines. Additionally, the metadata for the place and route tools may be modified to support additional rules, restrictions, and/or preferences for flow engines and multiple, decentralized, RNGs. For example, place and route tools may be modified to layout predefined types of flow engines between multiple RNGs and one or more random number consumers randomly, based on a set of rules/restrictions/preferences (e.g., in the metadata), in the available spaces between the multiple RNGs and random number consumers. The place and route tools may layout the flow engines randomly to keep any single group within an organization from directly having access to an entire design for the multi-RNG system. For example, designers of the components (e.g., flow engines/RNGs/random number consumers), or even a group working on place and route, may not have ready access to how the components are placed together, how many of components are used, or an order of the components as the components may be placed randomly on a processor/SoC. In some cases, place and route tools may alter some parts of the circuit through special constants marked with appropriate metadata such as of type “RANDOM CONSTANT” (e.g., “DON'T CARE” type) bits. These special types of binary constants may be used to modify functionality at those specific bits for a specific reason. For example, an XOR or XNOR gate with one input at 0 may be removed, and replaced by a NOT gate if one input is at 1. The place and route algorithms may fix these bits to 0 or 1 at their convenience in order to simplify the circuit in the case of local congestion, if such congestion has occurred. This area of local congestion can be an area with relatively high density even after area reduction due to some simplifications. In some cases, special types of binary constants are not performed for any other gates than XOR or XNOR gates. The metadata for the place and route algorithms may specify an overall maximum number of bits which could be fixed to 0/1 by the place and route algorithm.

As an example of randomly placing components, a place and route tool may be provided with predesigned components (e.g., flow engines/RNGs/random number consumers as discussed above) along with metadata for how to place/connect the components. As indicated above, the metadata may provide a set of rules/restrictions/preferences for the predesigned components. As an example, the metadata may indicate, for example, for a set of RNGs and one or more random number consumers, a minimum number of flow engines (or a minimum number of a certain type of flow engine, such as at least 8 P engines to perform at least 8 permutations) that may be placed on a river between the set of RNGs and the one or more random number consumers, whether dummy flow engines should be inserted, whether the RNG or random number consumer may be surrounded by a river and/or dummy flow engines, whether the river may be surrounded by dummy flow engines, ratio of dummy flow engines to river flow engines, whether multiple rivers may be mixed, a minimum and/or maximum width (e.g., number of bits in the input/output random number) for flow engines of a river, whether to randomly insert audit engines, whether audit engines generally or specifically should be wider (e.g., used with a X engines that output more bits than input bits), whether certain random number consumers should have increased amounts of randomness, a percentage distribution between the types of flow engines that may be targeted, whether Z engines may be inserted on some rivers, whether a river may include circular/feedback branches, that a river may connect to a random number consumer through a B engine, and so forth. As an example, the metadata may indicate that any P engine or X engine have at least 128 bits of input, 256 bits of output, at least 8 P engines per river (e.g., of a type that performs either AES permutation, Ascon permutation, or another permutation algorithm), which may include audit engines, combiners, and Z engines for a certain number/set of RNGs and a certain number/set of random number consumers. The place and route tool may also randomly select a number (e.g., number>8) of P engines, a random number of X engines, a number of B engines based on the number of random number consumers, random number and type of dummy flow engines, etc. The place and route tool may then place the RNGs and random number consumers based on, for example available space on the processor/SoC being designed. The X, P, and Z flow engines may be placed in between, around, surrounding, etc. the RNGs, random number consumers, and/or other components based on the metadata and the space available on the processor/SoC. Audit engines may be randomly placed along the river, and B engines placed on the river coupled to the random number consumers. In some cases, the river powering each final buffered outlet or consumer-facing B engine may include at least one mixer connecting a certain number K of initial sources, where K is an integer and a parameter provided to the place and route algorithms, which generates a final mixing infrastructure with some freedom of action using the available space, according to a security policy specified by the manufacturer. A security policy may specify a minimum value of K to be obeyed.

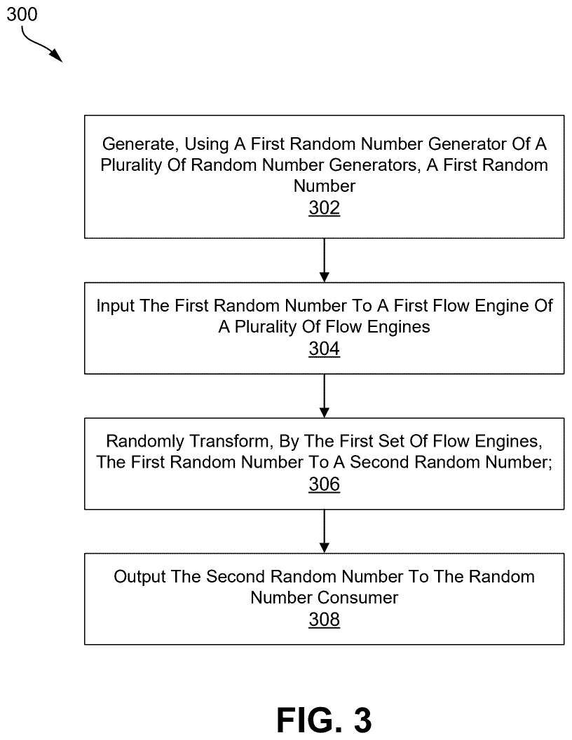

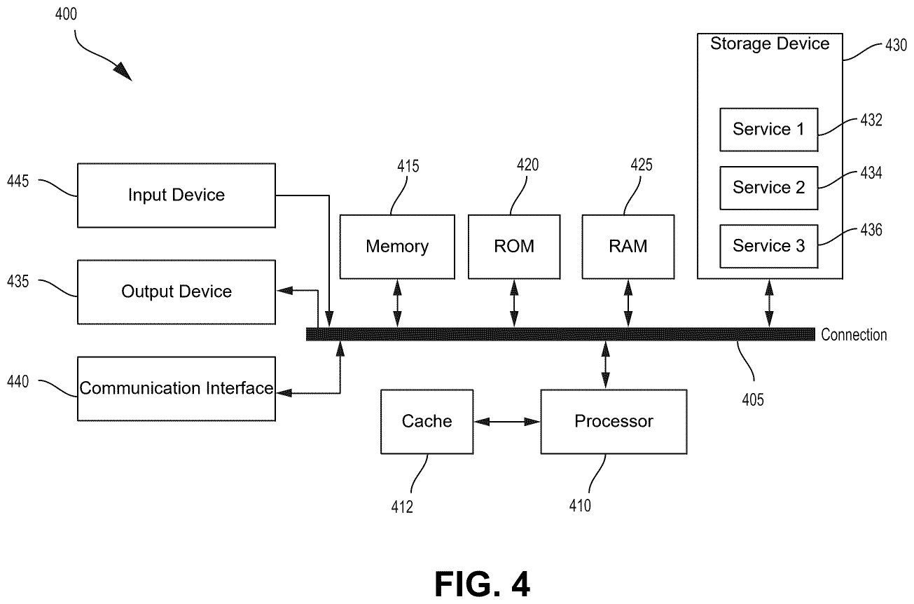

FIG. 3 is a flow diagram illustrating an example of a process 300 for generating random numbers, in accordance with aspects of the present disclosure. The process 300 may be performed by a wireless device or by a component (e.g., SoC 100 of FIG. 1, processor 410 of FIG. 4, etc.) or system (e.g., a chipset) of the wireless device (e.g., computing system 400). The electronic device may be a wireless device, such as computing system 400, or a ME (e.g., a mobile equipment, or other device such as a mobile phone, tablet a network-connected wearable such as a watch, an extended reality device such as a virtual reality (VR) device or augmented reality (AR) device, a vehicle or component or system of a vehicle, or other type of ME) or other type of network or cloud node or chiplet or computing sub-system. In some examples, the process 300 may be performed by a ME. The operations of the process 300 may be implemented, in part, as software components that are executed and run on one or more processors (e.g., CPU 102 of FIG. 1, processor 410 of FIG. 4, or other processor(s)).

At block 302, the computing device (or component thereof) may generate, using a first random number generator (e.g., first RNG 202 of FIG. 2) of a plurality of random number generators, a first random number.

At block 304, the computing device (or component thereof) may input the first random number to a first flow engine (e.g., P engine 212) of a plurality of flow engines (e.g., P engines 212 of FIG. 2, X engines 214 of FIG. 2, mixer 218 of FIG. 2, B engine 216 of FIG. 2, dummy P engines 222 of FIG. 2, dummy X engines 220 of FIG. 2, audit engines 224 of FIG. 2, etc.). The first flow engine may be coupled to a random number consumer (e.g., first crypto operation 208 of FIG. 2), of one or more random number consumers, through a first set of flow engines (e.g., river 206 of FIG. 2), of the plurality of flow engines. The plurality of flow engines may be unclocked. For example, the plurality of flow engines may be implemented using asynchronous digital logic. In some cases, the first set of flow engines may be coupled to a mixer flow engine. The mixer flow engine may transform and/or combine input from multiple sets of flow engines for output.

In some examples, each flow engine, of the plurality of flow engines are configured to perform an operation, such as a permutation operation, an exclusive or (XOR) operation, a buffer operation, a zeroing operation, an audit operation, or any combination thereof. In some cases, a minimum number of permutation operations are performed to randomly transform the first random number to the second random number. In some examples, a number of flow engines in the first set of flow engines is randomly determined, and wherein operations performed by the number of flow engines in the first set of flow engines are randomly determined. In some cases, the number of flow engines in the first set of flow engines is randomly determined by a place and route tool, and wherein the operations performed by the number of flow engines in the first set of flow engines are randomly determined by the place and route tool. In some examples, the number of flow engines in the first set of flow engines is randomly determined by a place and route tool based on at least one bit of metadata for the place and route tool, command line argument for the place and route tool, or a configuration file of the place and route tool, and wherein the operations performed by the number of flow engines in the first set of flow engines are randomly determined by the place and route tool based on at least one bit of metadata for the place and route tool, command line argument for the place and route tool, a configuration file of the place and route tool, any combination thereof, or other factors. For example, a designer of a circuit including a flow engine may use a variable of the place and route tool to indicate to the place and route tool to adequately determine (e.g., randomly determine or otherwise adequately determine) the number and/or operations for the flow engines. Similarly, a manufacturer metadata for the place and route tool may indicate to the place and route tool to adequately determine (e.g., randomly determine or otherwise adequately determine) the number and/or operations for the flow engines. In some cases, the number and size of flow engines may lie within a range and may be reduced to better fit within available space in some geographic area of the SOC. In some examples, the number and size of flow engines in the first set of flow engines may be determined based on this range.

In some cases, the XOR operation is performed by a second flow engine (e.g., X engines 214 of FIG. 2) of the first set of flow engines and wherein the XOR operation is performed on a set of bits randomly selected from bits input to the second flow engine. In some examples, the set of bits randomly selected from bits input to the second flow engine are determined by a place and route tool. In some cases, at most K−1 constants in some XOR gate with K inputs are constants decided by a ROT secure enclave at boot time or at one personalization or device firmware update stage. For example, certain constants (e.g., special constants) may differ from chip to chip (e.g., between secure enclaves) and inserting some constants can help diversify an RNG to produce different numbers. In some cases, the place and route tool may specify that the certain contents (e.g., special constants) may be input (e.g., as input bits), for example, to a flow engine. The use (e.g., input) of the constants may be determined after factory personalization or even more frequently, such as during each boot cycle. In some examples, the buffer operation buffers the second random number for the first set of flow engines for output to the random number consumer. In some examples, a second flow engine (e.g., mixer 218 of FIG. 2) is included in the first set of flow engines and a second set of flow engines, and wherein the second flow engine mixes values of the first set of flow engines and the second set of flow engines. In some cases, the first set of flow engines includes input bits (e.g., input to an XOR) which can be fixed or specified by a place and route tool.

At block 306, the computing device (or component thereof) may randomly transform, by the first set of flow engines, the first random number to a second random number. In some cases, a buffer flow engine may buffer values received by the set of flow engines to produce a stable signal indicating the second random number. In some cases, flow engines (e.g., dummy P engines 222 of FIG. 2, dummy X engines 220 of FIG. 2, etc.), of the plurality of flow engines, are placed around the random number consumer, and wherein the flow engines placed around the random number consumer generate noise emissions to mask emissions of at least one of the random number consumer, or one or more flow engines of the first set of flow engines. For example, the dummy flow engines may produce noise to mask emissions of the second crypto operation 210 of FIG. 2. The dummy flow engines may also produce noise to mask emissions of one or more rivers 206 of FIG. 2. In some examples, the plurality of flow engines includes one or more dummy flow engines separate from the first set of flow engines, and wherein the one or more dummy flow engines perform operations to generate noise emissions. In some cases, the one or more dummy flow engines obtains an input value from a separate source (e.g., separate from the first RNG 202 of FIG. 2) than the first flow engine. In some examples, a second flow engine (e.g., audit engines 224 of FIG. 2) is configured to perform an audit operation, and wherein the second flow engine is configured to output one of an alarm signal (e.g., alarm 226 of FIG. 2) or an indication to throttle signal. In some cases, the indication to throttle signal may enable one or more Z engines.

At block 308, the computing device (or component thereof) may buffer the second random number from the first set of flow engines for output to the random number consumer. For example, a set of flow engines may include a buffer engine (e.g., B engine) which may sample the unclocked asynchronous signals from the set of flow engines and buffer some of the unclocked asynchronous signals to produce a stable signal (e.g., the second random number) from the set of flow engines. This random number may be output to a random number consumer.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 300 and/or other processes described herein may include a processor, microprocessor, micro-computer, or other component of a device that is configured to carry out the steps of the process 300 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data. In some cases, a small number of bits produced by one or more sensors, such as low-ranking bits in audio or video signals, may be used to increase entropy of one or more RNGs. For example, the bits may be input to rivers at convenient places (e.g., at the discretion of place and route algorithms) in place of constants of type “RANDOM CONSTANT” (e.g., “DON'T CARE” type) which place and route are allowed to modify, in limited quantities that should not exceeded a manufacturer policy in metadata, in command line, configuration file options, etc. for an EDA tool.

The components of the device or apparatus configured to carry out one or more operations of the process 300 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 300 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 300 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 4 is a diagram illustrating an example of a system for implementing certain aspects of the present technology. In particular, FIG. 4 illustrates an example of computing system 400, which may be for example any computing device making up internal computing system, a remote computing system, a camera, or any component thereof in which the components of the system are in communication with each other using connection 405. Connection 405 may be a physical connection using a bus, or a direct connection into processor 410, such as in a chipset architecture. Connection 405 may also be a virtual connection, networked connection, or logical connection.

In some aspects, computing system 400 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example computing system 400 includes at least one processing unit (CPU or processor) 410 and connection 405 that communicatively couples various system components including system memory 425, such as read-only memory (ROM) 420 and random access memory (RAM) 425 to processor 410. Computing system 400 may include a cache 412 of high-speed memory connected directly with, in close proximity to, or integrated as part of processor 410. In some cases, an RNG outlet can also be connected in close proximity or integrated as part of any processor of the computing system 400.

Processor 410 may include any general-purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which may represent any number of input mechanisms, such as a microphone for speech, a touch-sensitive screen for gesture or graphical input, keyboard, mouse, motion input, speech, etc. Computing system 400 may also include output device 435, which may be one or more of a number of output mechanisms. In some instances, multimodal systems may enable a user to provide multiple types of input/output to communicate with computing system 400.

Computing system 400 may include communications interface 440, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 440 may also include one or more Global Navigation Satellite System (GNSS) receivers or transceivers that are used to determine a location of the computing system 400 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 430 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 430 may include software services, servers, services, etc., that when the code that defines such software is executed by the processor 410, it causes the system to perform a function. In some aspects, a hardware service that performs a particular function may include the software component stored in a computer-readable medium in connection with the necessary hardware components, such as processor 410, connection 405, output device 435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed by one or more processors, performs one or more of the methods, algorithms, and/or operations described above. The computer-readable data storage medium may form part of a computer program product, which may include packaging materials. The computer-readable medium and/or memory system may comprise any memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, memory 415, read-only memory (ROM) 420, random access memory (RAM) 425, storage device 430, and the like, and the computer-readable medium may include multiple memories or data storage media. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor system, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor system may be configured to perform any of the techniques described in this disclosure. A general-purpose processor may be a microprocessor; but in the alternative, the processor may be any conventional processor, controller, microcontroller, or state machine. A processor system may also be implemented as a combination of computing devices, e.g., a combination of a DSP and a microprocessor, a plurality of microprocessors, one or more microprocessors in conjunction with a DSP core, or any other such configuration. Accordingly, the term “processor system,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. An apparatus for random number generation, comprising: a memory system comprising instructions; and a processor system coupled the memory system, wherein the processor system is configured to: generate, using a first random number generator of a plurality of random number generators, a first random number; input the first random number to a first flow engine of a plurality of flow engines, wherein the first flow engine is coupled to a random number consumer, of one or more random number consumers, through a first set of flow engines, of the plurality of flow engines, wherein the plurality of flow engines are unclocked; randomly transform, by the first set of flow engines, the first random number to a second random number; and buffer the second random number from the first set of flow engines for output to the random number consumer.
Aspect 2. The apparatus of Aspect 1, wherein flow engines, of the plurality of flow engines, are placed around the random number consumer, and wherein the flow engines placed around the random number consumer generate noise emissions to mask emissions of at least one of the random number consumer, or one or more flow engines of the first set of flow engines.
Aspect 3. The apparatus of any of Aspects 1-2, wherein the plurality of flow engines includes one or more dummy flow engines separate from the first set of flow engines, and wherein the one or more dummy flow engines perform operations to generate noise emissions.
Aspect 4. The apparatus of Aspect 3, wherein the one or more dummy flow engines obtains an input value from a separate source than the first flow engine.
Aspect 5. The apparatus of any of Aspects 1-4, wherein each flow engine, of the plurality of flow engines are configured to perform an operation comprising at least one of: a permutation operation; an exclusive or (XOR) operation; a buffer operation; a zeroing operation; or an audit operation.
Aspect 6. The apparatus of Aspect 5, wherein a minimum number of permutation operations are performed to randomly transform the first random number to the second random number.
Aspect 7. The apparatus of any of Aspects 5-6, wherein a number of flow engines in the first set of flow engines is randomly determined, and wherein operations performed by the number of flow engines in the first set of flow engines are randomly determined.
Aspect 8. The apparatus of Aspect 7 wherein the number of flow engines in the first set of flow engines is randomly determined by a place and route tool, and wherein the operations performed by the number of flow engines in the first set of flow engines are randomly determined by the place and route tool.
Aspect 9. The apparatus of Aspect 8, wherein the number of flow engines in the first set of flow engines is randomly determined by a place and route tool based on at least one bit of metadata for the place and route tool, command line argument for the place and route tool, or a configuration file of the place and route tool, and wherein the operations performed by the number of flow engines in the first set of flow engines are randomly determined by the place and route tool based on at least one bit of metadata for the place and route tool, command line argument for the place and route tool, or a configuration file of the place and route tool.
Aspect 10. The apparatus of any of Aspects 5-9, wherein the XOR operation is performed by a second flow engine of the first set of flow engines and wherein the XOR operation is performed on a set of bits randomly selected from bits input to the second flow engine.
Aspect 11. The apparatus of Aspect 10, wherein the set of bits randomly selected from bits input to the second flow engine by a place and route tool.
Aspect 13. The apparatus of any of Aspects 10-11, where at most K−1 constants in some XOR gate with K inputs are constants decided by a ROT secure enclave at boot time or at one personalization or device firmware update stage.
Aspect 14. The apparatus of any of Aspects 5-13, wherein the buffer operation buffers the second random number for the first set of flow engines for output to the random number consumer.
Aspect 15. The apparatus of any of Aspects 5-14, wherein a second flow engine is configured to perform an audit operation, and wherein the second flow engine is configured to output one of an alarm signal or an indication to throttle signal.
Aspect 16. The apparatus of any of Aspects 1-15, wherein a third flow engine is included in the first set of flow engines and a second set of flow engines, and wherein the third flow engine mixes values of the first set of flow engines and the second set of flow engines.
Aspect 17. The apparatus of any of Aspects 1-16, wherein the first set of flow engines includes special constants, which are input bits which can be fixed or specified by a place and route tool.
Aspect 18. A method for random number generation, comprising: generating, using a first random number generator of a plurality of random number generators, a first random number; inputting the first random number to a first flow engine of a plurality of flow engines, wherein the first flow engine is coupled to a random number consumer, of one or more random number consumers, through a first set of flow engines, of the plurality of flow engines, wherein the plurality of flow engines are unclocked; randomly transforming, by the first set of flow engines, the first random number to a second random number; and buffering the second random number from the first set of flow engines for output to the random number consumer.
Aspect 19. The method of Aspect 18, wherein flow engines, of the plurality of flow engines, are placed around the random number consumer, and wherein the flow engines placed around the random number consumer generate noise emissions to mask emissions of at least one of the random number consumer, or one or more flow engines of the first set of flow engines.
Aspect 20. The method of any of Aspects 18-19, wherein the plurality of flow engines includes one or more dummy flow engines separate from the first set of flow engines, and wherein the one or more dummy flow engines perform operations to generate noise emissions.
Aspect 21. The method of Aspect 20, wherein the one or more dummy flow engines obtains an input value from a separate source than the first flow engine.
Aspect 22. The method of any of Aspects 18-21, wherein each flow engine, of the plurality of flow engines are configured to perform an operation comprising at least one of: a permutation operation; an exclusive or (XOR) operation; a buffer operation; a zeroing operation; or an audit operation.
Aspect 23. The method of Aspect 22, wherein a minimum number of permutation operations are performed to randomly transform the first random number to the second random number.
Aspect 24. The method of any of Aspects 22-23, wherein a number of flow engines in the first set of flow engines is randomly determined, and wherein operations performed by the number of flow engines in the first set of flow engines are randomly determined.
Aspect 25. The method of Aspect 24 wherein the number of flow engines in the first set of flow engines is randomly determined by a place and route tool, and wherein the operations performed by the number of flow engines in the first set of flow engines are randomly determined by the place and route tool.
Aspect 26. The method of Aspect 25, wherein the number of flow engines in the first set of flow engines is randomly determined by a place and route tool based on at least one bit of metadata for the place and route tool, command line argument for the place and route tool, or a configuration file of the place and route tool, and wherein the operations performed by the number of flow engines in the first set of flow engines are randomly determined by the place and route tool based on at least one bit of metadata for the place and route tool, command line argument for the place and route tool, or a configuration file of the place and route tool.
Aspect 27. The method of any of Aspects 22-26, wherein the XOR operation is performed by a second flow engine of the first set of flow engines and wherein the XOR operation is performed on a set of bits randomly selected from bits input to the second flow engine.
Aspect 28. The method of Aspect 27, wherein the set of bits randomly selected from bits input to the second flow engine by a place and route tool.
Aspect 29. The method of any of Aspects 27-28, where at most K−1 constants in some XOR gate with K inputs are constants decided by a ROT secure enclave at boot time or at one personalization or device firmware update stage.
Aspect 30. The method of any of Aspects 22-29, wherein the buffer operation buffers the second random number for the first set of flow engines for output to the random number consumer.
Aspect 31. The method of any of Aspects 22-30, wherein a second flow engine is configured to perform an audit operation, and wherein the second flow engine is configured to output one of an alarm signal or an indication to throttle signal.
Aspect 32. The method of any of Aspects 18-31, wherein a third flow engine is included in the first set of flow engines and a second set of flow engines, and wherein the third flow engine mixes values of the first set of flow engines and the second set of flow engines.
Aspect 33. The method of any of Aspects 18-32, wherein the first set of flow engines includes special constants, which are input bits which can be fixed or specified by a place and route tool.
Aspect 34. A non-transitory computer-readable medium having stored thereon instructions that, when executed by at least one processor, cause the at least one processor to perform operations according to any of Aspects 18 to 33.
Aspect 35. An apparatus for random number generation, comprising one or more means for performing operations according to any of Aspects 18 to 33.
Aspect 36. An apparatus for random number generation, comprising: a combination of manufacturer defined engine boxes of several types, one or several processors coupled to memory and one or several hardware secure cryptographic computation units or enclaves, and one or several networking devices and I/O and multimedia subs-systems, physically connected by design and place and route tools and configured to: generate, using a first random number generator of a plurality of random number generators, a first random number; input the first random number to a first flow engine of a plurality of flow engines, wherein the first flow engine is connected to a sequence of further transformations mixing bits from a multiplicity of random sources, wherein the initial plurality of flow engines are unclocked and they randomly transform, each first random number to some different random number; and are finally connected to one or more buffered random number consumers or outlets.

What is claimed is:

1. An apparatus for random number generation, comprising:
a memory system comprising instructions; and
a processor system coupled the memory system, wherein the processor system is configured to:
generate, using a first random number generator of a plurality of random number generators, a first random number;
input the first random number to a first flow engine of a plurality of flow engines, wherein the first flow engine is coupled to a random number consumer, of one or more random number consumers, through a first set of flow engines, of the plurality of flow engines, wherein the plurality of flow engines are unclocked;
randomly transform, by the first set of flow engines, the first random number to a second random number; and
buffer the second random number from the first set of flow engines for output to the random number consumer.

2. The apparatus of claim 1, wherein flow engines, of the plurality of flow engines, are placed around the random number consumer, and wherein the flow engines placed around the random number consumer generate noise emissions to mask emissions of at least one of the random number consumer, or one or more flow engines of the first set of flow engines.

3. The apparatus of claim 1, wherein the plurality of flow engines includes one or more dummy flow engines separate from the first set of flow engines, and wherein the one or more dummy flow engines perform operations to generate noise emissions.

4. The apparatus of claim 3, wherein the one or more dummy flow engines obtains an input value from a separate source than the first flow engine.

5. The apparatus of claim 1, wherein each flow engine, of the plurality of flow engines are configured to perform an operation comprising at least one of:
a permutation operation;
an exclusive or (XOR) operation;
a buffer operation;
a zeroing operation; or
an audit operation.

6. The apparatus of claim 5, wherein a minimum number of permutation operations are performed to randomly transform the first random number to the second random number.

7. The apparatus of claim 5, wherein a number of flow engines in the first set of flow engines is randomly determined, and wherein operations performed by the number of flow engines in the first set of flow engines are randomly determined.

8. The apparatus of claim 7 wherein the number of flow engines in the first set of flow engines is randomly determined by a place and route tool, and wherein the operations performed by the number of flow engines in the first set of flow engines are randomly determined by the place and route tool.

9. The apparatus of claim 8, wherein the number of flow engines in the first set of flow engines is randomly determined by a place and route tool based on at least one bit of metadata for the place and route tool, command line argument for the place and route tool, or a configuration file of the place and route tool, and wherein the operations performed by the number of flow engines in the first set of flow engines are randomly determined by the place and route tool based on at least one bit of metadata for the place and route tool, command line argument for the place and route tool, or a configuration file of the place and route tool.

10. The apparatus of claim 5, wherein the XOR operation is performed by a second flow engine of the first set of flow engines and wherein the XOR operation is performed on a set of bits randomly selected from bits input to the second flow engine.

11. The apparatus of claim 10, wherein the set of bits randomly selected from bits input to the second flow engine by a place and route tool.

12. The apparatus of claim 10, where at most K−1 constants in some XOR gate with K inputs are constants decided by a ROT secure enclave at boot time or at one personalization or device firmware update stage.

13. The apparatus of claim 5, wherein the buffer operation buffers the second random number for the first set of flow engines for output to the random number consumer.

14. The apparatus of claim 5, wherein a second flow engine is configured to perform an audit operation, and wherein the second flow engine is configured to output one of an alarm signal or an indication to throttle signal.

15. The apparatus of claim 1, wherein a third flow engine is included in the first set of flow engines and a second set of flow engines, and wherein the third flow engine mixes values of the first set of flow engines and the second set of flow engines.

16. The apparatus of claim 1, wherein the first set of flow engines includes special constants, which are input bits which can be fixed or specified by a place and route tool.

17. A method for random number generation, comprising:
generating, using a first random number generator of a plurality of random number generators, a first random number;
inputting the first random number to a first flow engine of a plurality of flow engines, wherein the first flow engine is coupled to a random number consumer, of one or more random number consumers, through a first set of flow engines, of the plurality of flow engines, wherein the plurality of flow engines are unclocked;
randomly transforming, by the first set of flow engines, the first random number to a second random number; and
buffering the second random number from the first set of flow engines for output to the random number consumer.

18. The method of claim 17, wherein flow engines, of the plurality of flow engines, are placed around the random number consumer, and wherein the flow engines placed around the random number consumer generate noise emissions to mask emissions of at least one of the random number consumer, or one or more flow engines of the first set of flow engines.

19. The method of claim 17, wherein the plurality of flow engines includes one or more dummy flow engines separate from the first set of flow engines, and wherein the one or more dummy flow engines perform operations to generate noise emissions.

20. The method of claim 17, wherein each flow engine, of the plurality of flow engines are configured to perform an operation comprising at least one of:
a permutation operation;
an exclusive or (XOR) operation;
a buffer operation;
a zeroing operation; or
an audit operation.
